(19) United States
(12) Patent Application Publication
(10) Pub. No.: US 2020/0353798 A1
(43) Pub. Date: Nov. 12, 2020

(54) AIR-CONDITIONING SYSTEM FOR VEHICLE AND CARBON DIOXIDE CAPTURE MODULE USED THEREFOR

(71) Applicants: Hyundai Motor Company, Seoul (KR); Kia Motors Corporation, Seoul (KR)

(72) Inventors: Sol Kim, Suwon-si (KR); Sang Hak Kim, Seoul (KR)

(21) Appl. No.: 16/667,555

(22) Filed: Oct. 29, 2019

(30) Foreign Application Priority Data
May 10, 2019 (KR) 10-2019-0055102

(51) Int. Cl. B60H 3/00; B60H 1/00; B60H 3/06

(52) U.S. Cl. CPC B60H 3/0092; B60H 2001/00178; B60H 3/0641; B60H 1/00835

(57) ABSTRACT

An air-conditioning system for a vehicle includes: a blower unit connected to an internal air flow path and an external air flow path and configured to selectively suction or discharge air; a flow path housing configured to guide air suctioned through the blower unit to the interior of the vehicle; a carbon dioxide capture module configured to selectively capture carbon dioxide contained in the air flowing into the flow path housing; and a door disposed between the flow path housing and the carbon dioxide capture module in order to selectively open or close the flow path housing.

### CROSS-REFERENCE TO RELATED APPLICATION

This application claims the benefit of priority to Korean Patent Application No. 10-2019-0055102, filed on May 10, 2019 in the Korean Intellectual Property Office, the disclosure of which is incorporated herein by reference.

### TECHNICAL FIELD

The present disclosure relates to an air-conditioning system for a vehicle, and more particularly, to an air-conditioning system for a vehicle and a carbon dioxide capture module used therefor for reducing the concentration of carbon dioxide in the vehicle and maintaining the capture performance of the carbon dioxide capture module.

### BACKGROUND

In general, a vehicle is provided with an air-conditioning system for ventilating internal air and controlling a temperature.

Specifically, a heating device of an air-conditioning system serves to increase the indoor temperature of a vehicle by heating internal air and external air, which are introduced thereinto through a blower unit, using a heater core and supplying the heated air to the interior of the vehicle, and a cooling device serves to lower the indoor temperature of a vehicle by cooling internal air and external air, which are introduced thereinto, using an evaporator and supplying the cooled air to the interior of the vehicle.

In addition, the air-conditioning system is provided with an air filter for filtering foreign substances, such as dust, moisture, and toxic fumes, contained in the air flowing into the vehicle. Various viruses, bacteria, and fungi contained in the air, as well as various foreign substances such as dust, moisture, and toxic particles, may be filtered by the air filter.

However, the air filter of the air-conditioning system filters various viruses, bacteria, and fungi contained in the air, as well as foreign substances such as dust, moisture, and toxic particles, but is not capable of reducing a sharply increased amount of carbon dioxide from the interior of the vehicle.

Since the indoor space of a vehicle is relatively small and hermetically sealed, when a relatively large number of passengers is in the vehicle, the internal air quickly becomes stale, and the concentration of carbon dioxide increases sharply due to breathing of the passengers. This causes drowsiness when driving, headaches, difficulty concentrating, etc., and consequently increases the risk of a traffic accident.

Therefore, while the vehicle is traveling, it is necessary to frequently ventilate the internal air by opening the windows or activating the external air mode.

However, when the windows are opened or the external air mode is activated while the vehicle is traveling, the concentration of carbon dioxide in the vehicle may be lowered, but fine dust, toxic fumes, and the like may be introduced into the vehicle, and the cooling/heating load may increase, thus deteriorating energy efficiency.

Therefore, in recent years, various research has been made to reduce the concentration of carbon dioxide in a vehicle while minimizing deterioration in energy efficiency and preventing the introduction of fine dust and toxic fumes, but results thereof are insufficient, and thus there is a need for the development thereof.

### SUMMARY

The present disclosure has been made in view of the above problems, and it is an object of the present disclosure to provide an air-conditioning system for a vehicle and a carbon dioxide capture module used therefor for reducing the concentration of carbon dioxide in a vehicle and maintaining the performance of the carbon dioxide capture module.

It is another object of the present disclosure to enable a reduction in the concentration of carbon dioxide in a vehicle in an internal air mode and enable the regeneration of a carbon dioxide capture module without contaminating the interior of the vehicle.

In accordance with an aspect of the present disclosure, an air-conditioning system for a vehicle includes: a blower unit connected to an internal air flow path and an external air flow path, the blower unit being configured to selectively suction or discharge air; a flow path housing configured to guide air suctioned through the blower unit to the interior of the vehicle; a carbon dioxide capture module configured to selectively capture carbon dioxide contained in the air flowing into the flow path housing; and a door disposed between the flow path housing and the carbon dioxide capture module, the door being configured to selectively open or close the flow path housing.

Thus, it is possible to reduce the concentration of carbon dioxide in the vehicle and to maintain the capture performance of the carbon dioxide capture module.

In a related art, while a vehicle is traveling, the windows are opened or an external air mode is activated in order to lower the concentration of carbon dioxide in the vehicle. However, fine dust, toxic fumes, and the like may be introduced into the vehicle, and the cooling/heating load (inflow of cold external air or hot external air) may increase, thus deteriorating energy efficiency.

According to the present disclosure, the carbon dioxide capture module may be disposed in a circulation path through which the internal air in the vehicle circulates, and may capture carbon dioxide contained in the air flowing into the interior of the vehicle. Thus, it is possible to reduce the concentration of carbon dioxide in the vehicle while preventing the introduction of fine dust and toxic fumes and to prevent deterioration in energy efficiency attributable to an increase in a cooling/heating load.

When the operation time of the carbon dioxide capture module exceeds a predetermined time period (or when the amount of carbon dioxide that is captured reaches an upper limit value), the door may close the flow path housing. In this state, the carbon dioxide capture module may be regenerated (carbon dioxide captured in the carbon dioxide capture module may be desorbed therefrom) without contaminating the interior of the vehicle. Thus, it is possible to maintain the constant capture performance of the carbon dioxide capture module, to increase the lifespan of the carbon dioxide capture module, and to improve the efficiency of removal of carbon dioxide from the vehicle.

When the door opens the flow path housing, carbon dioxide may be captured in the carbon dioxide capture module, and when the door closes the flow path housing, the carbon dioxide captured in the carbon dioxide capture module may be desorbed therefrom.

The air-conditioning system may further include a mode-switching door configured to switch an air supply mode to any one of an internal air mode in which the blower unit communicates with the internal air flow path and an external air mode in which the blower unit communicates with the external air flow path. In the internal air mode, the door may open the flow path housing, and the carbon dioxide capture module may capture carbon dioxide contained in the air introduced through the internal air flow path.

When the mode-switching door is disposed so as to activate the external air mode, the door may close the flow path housing, and the blower unit may discharge carbon dioxide desorbed from the carbon dioxide capture module to the external air flow path.

The carbon dioxide capture module may be disposed at any of various points in the flow path along which air flows into the flow path housing (the interior of the vehicle).

The carbon dioxide capture module may be disposed between the blower unit and the flow path housing. Specifically, the carbon dioxide capture module may be arranged between the blower unit and an evaporator for cooling the air introduced into the flow path housing.

The carbon dioxide capture module may be arranged between the internal air flow path and the blower unit.

The carbon dioxide capture module may include a carbon dioxide absorbent to which carbon dioxide is adsorbed and a heater for heating the carbon dioxide absorbent.

When the carbon dioxide absorbent is heated to a first temperature range, carbon dioxide contained in the air passing through the carbon dioxide capture module may be adsorbed to the carbon dioxide absorbent. When the carbon dioxide absorbent is heated to a second temperature range, which is higher than the first temperature range, the carbon dioxide adsorbed to the carbon dioxide absorbent may be desorbed therefrom. The first temperature range may be set to be 30 to 80° C., and the second temperature range may be set to be 90° C. or higher.

The heater may include a planar heating element stacked on one surface of the carbon dioxide absorbent, and a protective layer, which has a structure that allows air to pass therethrough, may be disposed on the opposite surface of the carbon dioxide absorbent.

In accordance with another aspect of the present disclosure, a carbon dioxide capture module includes: a carbon dioxide absorbent disposed in a flow path along which air flows into the interior of a vehicle, the carbon dioxide absorbent being configured to selectively adsorb carbon dioxide; and a heater configured to heat the carbon dioxide absorbent.

When the carbon dioxide absorbent is heated to a first temperature range, carbon dioxide may be adsorbed to the carbon dioxide absorbent. When the carbon dioxide absorbent is heated to a second temperature range, which is higher than the first temperature range, the carbon dioxide adsorbed to the carbon dioxide absorbent may be desorbed therefrom.

In one example, the first temperature range may be set to be 30 to 80° C., and the second temperature range may be set to be 90° C. or higher.

The heater may include a planar heating element stacked on one surface of the carbon dioxide absorbent, and a protective layer, which has a structure that allows air to pass therethrough, may be stacked on the opposite surface of the carbon dioxide absorbent.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view illustrating an air-conditioning system for a vehicle according to an exemplary embodiment of the present disclosure;

FIG. 2 is a view illustrating the process of capturing carbon dioxide by the air-conditioning system for a vehicle according to an exemplary embodiment of the present disclosure;

FIG. 3 is a view illustrating the process of discharging carbon dioxide by the air-conditioning system for a vehicle according to an exemplary embodiment of the present disclosure;

FIG. 4 is a view illustrating a carbon dioxide capture module of the air-conditioning system for a vehicle according to an exemplary embodiment of the present disclosure;

FIG. 5 is a view illustrating one example of a planar heating element of the air-conditioning system for a vehicle according to an exemplary embodiment of the present disclosure;

FIG. 6 is a view illustrating another example of a planar heating element of the air-conditioning system for a vehicle according to an exemplary embodiment of the present disclosure; and

FIG. 7 is a view illustrating an air-conditioning system for a vehicle according to another exemplary embodiment of the present disclosure.

### DETAILED DESCRIPTION

Advantages and features of the present disclosure and methods for achieving them will become apparent from the descriptions of aspects herein below with reference to the accompanying drawings. However, the present disclosure is not limited to the aspects disclosed herein, but may be implemented in various different forms. The aspects are provided to make the description of the present disclosure thorough and to fully convey the scope of the present disclosure to those skilled in the art. It is to be noted that the scope of the present disclosure is defined only by the claims. Like reference numerals designate like elements throughout the specification. In relation to describing the present disclosure, when a detailed description of relevant known technology is determined to unnecessarily obscure the gist of the present disclosure, the detailed description may be omitted.

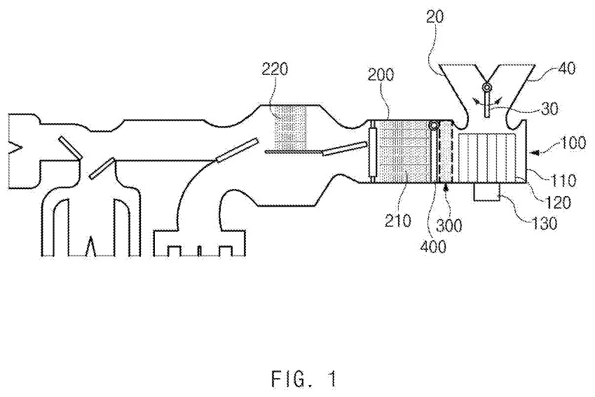

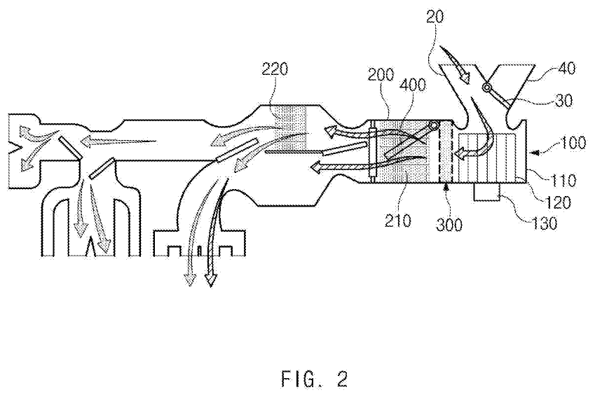

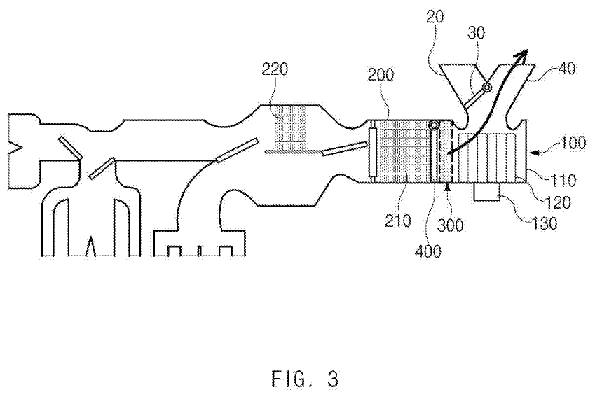

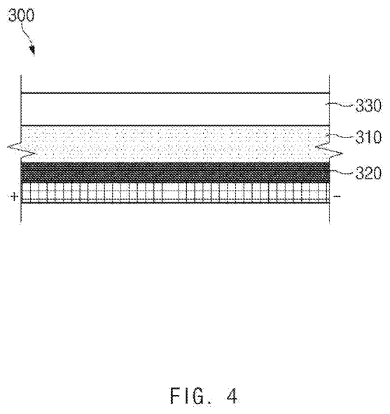

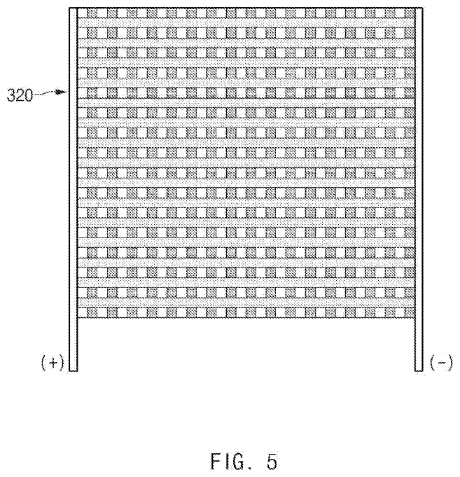

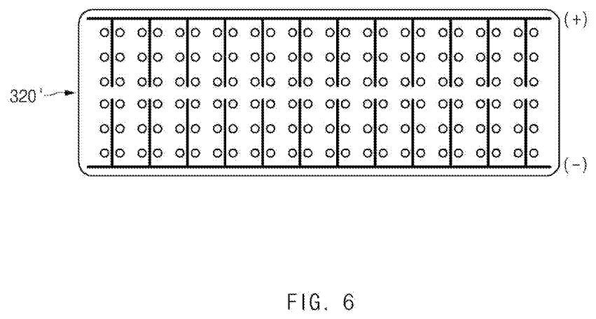

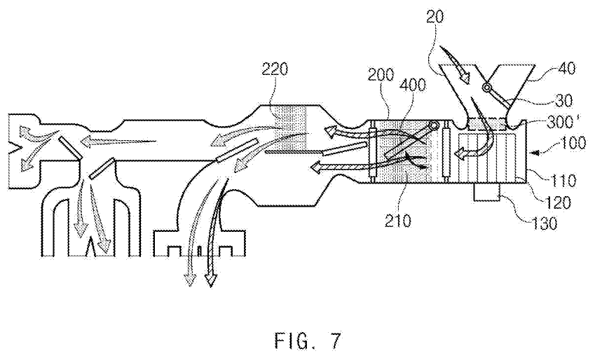

FIG. 1 is a view illustrating an air-conditioning system for a vehicle according to an exemplary embodiment of the present disclosure, FIG. 2 is a view illustrating the process of capturing carbon dioxide by the air-conditioning system for a vehicle according to an exemplary embodiment of the present disclosure, and FIG. 3 is a view illustrating the process of discharging carbon dioxide by the air-conditioning system for a vehicle according to an exemplary embodiment of the present disclosure. FIG. 4 is a view illustrating a carbon dioxide capture module of the air-conditioning system for a vehicle according to an exemplary embodiment of the present disclosure, FIG. 5 is a view illustrating one example of a planar heating element of the air-conditioning system for a vehicle according to an exemplary embodiment of the present disclosure, and FIG. 6 is a view illustrating another example of a planar heating element of the air-conditioning system for a vehicle according to an exemplary embodiment of the present disclosure. FIG. 7 is a view illustrating an air-conditioning system for a vehicle according to another exemplary embodiment of the present disclosure.

Referring to FIGS. 1 to 7, an air-conditioning system for a vehicle according to the present disclosure includes a blower unit 100, which is connected to an internal air flow path 20 and an external air flow path 40 and selectively suctions or discharges air, a flow path housing 200, which guides the air suctioned through the blower unit 100 to the interior of the vehicle, a carbon dioxide capture module 300, which selectively captures carbon dioxide contained in the air flowing into the flow path housing 200, and an opening/closing door 400, which is disposed between the flow path housing 200 and the carbon dioxide capture module 300 and selectively opens or closes the flow path housing 200.

The blower unit 100 is installed at one side in the vehicle in order to suction external air into the interior of the vehicle or to circulate internal air in the interior of the vehicle.

In one example, the blower unit 100 includes a blower housing 110, which is connected to the internal air flow path 20 and the external air flow path 40 and allows air to flow therethrough, a blower 120, which is installed in the blower housing 110 and forces air to flow, and a motor 130, which rotates the blower 120, thereby forcibly suctioning or discharging the internal air or the external air.

In the present disclosure, the internal air flow path 20 is a flow path that is connected to the blower housing 110 in order to circulate the internal air in the vehicle, and the external air flow path 40 is a flow path that is connected to the blower housing 110 in order to introduce external air from outside the vehicle.

The shapes and structures of the internal air flow path 20 and the external air flow path 40 may be variously changed depending on the required conditions and design specifications. The present disclosure is not restricted or limited to any specific shape or structure of the internal air flow path 20 or the external air flow path 40.

The connection structures and connection positions between the blower housing 110 and the internal air flow path 20 and between the blower housing 110 and the external air flow path 40 may be variously changed depending on the required conditions and design specifications.

In one example, referring to FIG. 1, the internal air flow path 20 may be connected to the upper left portion of the blower housing 110, and the external air flow path 40 may be connected to the upper right portion of the blower housing 110.

In addition, the blower unit 100 is provided at the inlet portion thereof with a mode-switching door 30 for switching the air supply mode to any one of an internal air mode, in which the blower unit 100 communicates with the internal air flow path 20, and an external air mode, in which the blower unit 100 communicates with the external air flow path 40.

In one example, the mode-switching door 30 may be configured to rotate about a hinge (not shown) provided at one end thereof to open or close the internal air flow path 20 or the external air flow path 40.

Specifically, in the state in which the external air flow path 40 is closed by the mode-switching door 30, air is supplied to the blower unit 100 via the internal air flow path 20, and in the state in which the internal air flow path 20 is closed by the mode-switching door 30, air is supplied to the blower unit 100 via the external air flow path 40.

The flow path housing 200 is provided to guide the air suctioned through the blower unit 100 to the interior of the vehicle.

In one example, a plurality of ducts (not shown) is connected to the flow path housing 200, and the air introduced into the flow path housing 200 is supplied to the interior of the vehicle via each duct.

A heater core 220 for heating the air introduced into the flow path housing 200 and an evaporator 210 for cooling the air introduced into the flow path housing 200 may be provided inside the flow path housing 200. The path along which the air flows inside the flow path housing 200 may be controlled in response to the air-conditioning setting operation by the user.

The carbon dioxide capture module 300 is provided to selectively capture carbon dioxide contained in the air flowing into the flow path housing 200.

In one example, the carbon dioxide capture module 300 includes a carbon dioxide absorbent 310 to which carbon dioxide is adsorbed and a heater 320 for heating the carbon dioxide absorbent 310.

The carbon dioxide absorbent 310 is configured to capture carbon dioxide in a dry capture manner.

Specifically, the carbon dioxide absorbent 310 may capture carbon dioxide (CO₂) through an absorption reaction. The carbon dioxide absorbent 310, having absorbed carbon dioxide, may be regenerated using heat and may desorb high-concentration carbon dioxide through a regeneration reaction. The regenerated carbon dioxide absorbent 310 may be recycled to the absorption reaction and may be reused. Through such a recycling process (absorption→regeneration), the process of rapidly capturing a large amount of carbon dioxide (the absorption reaction) and the process of desorbing high-concentration carbon dioxide (the regeneration reaction) may be repeatedly performed, thereby enabling the isolation of carbon dioxide at low cost.

In one example, a spherical solid powder such as potassium carbonate or sodium carbonate may be used as the carbon dioxide absorbent 310. The present disclosure is not restricted or limited to any specific type or characteristic of the carbon dioxide absorbent 310.

The active component of the carbon dioxide absorbent (the solid absorbent) 310 may be alkali metal carbonate, alkaline earth metal carbonate, or solid amine. The general reaction formulas of alkali metal in the respective reactions (the absorption reaction and the regeneration reaction) are as follows.

Absorption Reaction: M₂CO₃(s)+H₂O(g)+CO₂(g)→2MHCO₃(S) Exothermic Reaction

Regeneration Reaction: 2MHCO₃(S)→M₂CO₃(s)+CO₂(g)+H₂O(g) Endothermic Reaction

The heater 320 is provided to heat the carbon dioxide absorbent 310 in order to realize the absorption reaction and the regeneration reaction of the carbon dioxide absorbent 310.

In one example, when the carbon dioxide absorbent 310 is heated to a first temperature range, carbon dioxide contained in the air passing through the carbon dioxide capture module 300 is adsorbed to the carbon dioxide absorbent 310 (the absorption reaction). When the carbon dioxide absorbent 310 is heated to a second temperature range, which is higher than the first temperature range, the carbon dioxide adsorbed to the carbon dioxide absorbent 310 is desorbed from the carbon dioxide absorbent 310 (the regeneration reaction).

The first temperature range may be set to be 30 to 80° C., and the second temperature range may be set to be 90° C. or higher. The first temperature range may be set to be 40 to 70° C., and the second temperature range may be set to be 100° C. or higher.

Any of various heating elements capable of heating the carbon dioxide absorbent 310 may be used as the heater 320.

In one example, in order to evenly heat the carbon dioxide absorbent 310, which is disposed in a layered structure (or a plate-shaped structure), a planar heating element having an area corresponding to the carbon dioxide absorbent 310 may be used as the heater 320.

The planar heating element may be stacked so as to be in close contact with one surface of the carbon dioxide absorbent 310.

Specifically, as shown in FIG. 5, a woven-type planar heating element having a mesh structure that allows air to pass therethrough may be used as the heater 320. According to another exemplary embodiment of the present disclosure, as shown in FIG. 6, a printed-type planar heating element (or a lattice-printed-type planar heating element), through which through-holes (not shown) are formed so as to allow air to pass therethrough, may be used as a heater 320′. In some cases, any of various other types of planar heating elements may be used as the heater.

In addition, a protective layer 330 may be provided on the opposite surface of the carbon dioxide absorbent 310 in order to protect the carbon dioxide absorbent 310.

The protective layer 330 is formed in a mesh-type structure to allow air to pass therethrough, and is disposed so as to be stacked on the opposite surface of the carbon dioxide absorbent 310.

The material of the protective layer 330 may be variously changed depending on the required conditions and design specifications.

The carbon dioxide capture module 300 may be disposed at any of various points in the flow path along which air flows into the flow path housing 200 (the interior of the vehicle).

In one example, referring to FIG. 2, the carbon dioxide capture module 300 may be disposed between the blower unit 100 and the flow path housing 200. Specifically, the carbon dioxide capture module 300 may be provided between the blower unit 100 and the evaporator 210 for cooling the air introduced into the flow path housing 200.

The air that has passed through the blower unit 100 passes through the carbon dioxide capture module 300 before entering the flow path housing 200 (the evaporator). Thus, the carbon dioxide capture module 300 is capable of capturing carbon dioxide contained in the air flowing into the flow path housing 200.

In another example, referring to FIG. 7, a carbon dioxide capture module 300′ may be provided between the internal air flow path 20 and the blower unit 100.

The air introduced through the internal air flow path 20 passes through the carbon dioxide capture module 300′ before entering the blower unit 100. Thus, the carbon dioxide capture module 300′ is capable of capturing carbon dioxide contained in the air flowing into the blower unit 100.

The opening/closing door 400 is provided between the flow path housing 200 and the carbon dioxide capture module 300 in order to selectively open or close the flow path housing 200.

Here, opening or closing of the flow path housing 200 means allowance or interruption of the air flow from the blower unit 100 to the flow path housing 200.

The opening/closing door 400 may be configured to open or close the flow path housing 200 in any of various manners depending on the required conditions and design specifications.

In one example, the opening/closing door 400 may be configured to rotate about a hinge (not shown) provided at one end thereof to open or close the flow path housing 200. According to another exemplary embodiment of the present disclosure, the opening/closing door may be configured to move in a sliding manner or to operate in a folding manner to open or close the flow path housing.

Specifically, when the opening/closing door 400 opens the flow path housing 200, carbon dioxide is captured in the carbon dioxide capture module 300, and when the opening/closing door 400 closes the flow path housing 200, the carbon dioxide captured in the carbon dioxide capture module 300 is desorbed therefrom.

That is, in the internal air mode, in which the mode-switching door 30 closes the external air flow path 40, the opening/closing door 400 opens the flow path housing 200 and the carbon dioxide capture module 300 captures carbon dioxide contained in the air introduced through the internal air flow path 20.

When the mode-switching door 30 is disposed so as to activate the external air mode, the opening/closing door 400 closes the flow path housing 200, and the blower unit 100 discharges the carbon dioxide desorbed from the carbon dioxide capture module 300 to the external air flow path 40.

With the configuration in which the opening/closing door 400 is provided between the flow path housing 200 and the carbon dioxide capture module 300 and in which the flow path housing 200 is selectively opened or closed by the opening/closing door 400, the air that has passed through the carbon dioxide capture module 300 (the air from which carbon dioxide has been removed) may flow into the flow path housing 200 (the opening of the opening/closing door 400), and the carbon dioxide desorbed from the carbon dioxide capture module 300 may be prevented from flowing into the flow path housing 200 (closing of the opening/closing door 400) during the regeneration of the carbon dioxide capture module 300.

Hereinafter, a method of driving the air-conditioning system for a vehicle according to the present disclosure will be described.

First, when the internal air mode is activated, the mode-switching door 30 closes the external air flow path 40.

Subsequently, the blower 120 is driven, and thus the air in the cabin (not shown) circulates along the internal air flow path 20.

Subsequently, power is applied to the carbon dioxide capture module 300 such that the temperature of the heater 320 (the planar heating element) is adjusted to the first temperature range (40˜70° C.), and carbon dioxide contained in the air passing through the carbon dioxide absorbent 310 is adsorbed to the surface of the carbon dioxide absorbent 310.

Subsequently, when the operation time of the carbon dioxide capture module 300 exceeds a predetermined time period (or when the amount of carbon dioxide that is captured reaches an upper limit value), the opening/closing door 400 closes the flow path housing 200, and the mode-switching door 30 closes the internal air flow path 20.

Subsequently, when the temperature of the heater 320 is adjusted to the second temperature range (100° C.), the carbon dioxide adsorbed to the surface of the carbon dioxide absorbent 310 is desorbed from the carbon dioxide absorbent 310. Simultaneously with the desorption of carbon dioxide from the carbon dioxide absorbent 310, the blower 120 is driven in order to discharge the carbon dioxide desorbed from the carbon dioxide absorbent 310 to the outside via the external air flow path 40.

Subsequently, when the regeneration of the carbon dioxide capture module 300 (the carbon dioxide absorbent) is completed, the mode-switching door 30 opens the internal air flow path 20, and at the same time the opening/closing door 400 opens the flow path housing 200. Thus, the mode in which air is supplied to the blower unit 100 is switched to the internal air mode. In the internal air mode, the carbon dioxide capture module 300 captures carbon dioxide contained in the air.

In some cases, the user may manually switch the air supply mode from the internal air mode to the external air mode (or from the external air mode to the internal air mode), and the operation of the carbon dioxide capture module 300 may be automatically performed when the internal air mode and/or the external air mode is activated (e.g. may be automatically operated when the internal air mode is activated).

As is apparent from the above description, according to the present disclosure, it is possible to reduce the concentration of carbon dioxide in a vehicle and to maintain the performance of a carbon dioxide capture module.

In particular, according to the present disclosure, it is possible to enable reduction in the concentration of carbon dioxide in a vehicle in an internal air mode and to enable regeneration of the carbon dioxide capture module without contaminating the interior of the vehicle. Thus, deterioration in the capture performance of the carbon dioxide capture module due to a cumulative amount of captured carbon dioxide may be minimized, the lifespan of the carbon dioxide capture module may be increased, and the efficiency of removal of carbon dioxide from the vehicle may be improved.

In addition, according to the present disclosure, it is possible to reduce the concentration of carbon dioxide in the vehicle while preventing the introduction of fine dust and toxic fumes and to prevent deterioration in energy efficiency attributable to an increase in a cooling/heating load.

Although the exemplary embodiments of the present disclosure have been disclosed for illustrative purposes, those skilled in the art will appreciate that various modifications, additions and substitutions are possible, without departing from the scope and spirit of the invention as disclosed in the accompanying claims.

What is claimed is:

1. An air-conditioning system for a vehicle, comprising:
a blower unit connected to an internal air flow path and an external air flow path, the blower unit being configured to selectively suction or discharge air;
a flow path housing configured to guide air suctioned through the blower unit to an interior of the vehicle;
a carbon dioxide capture module configured to selectively capture carbon dioxide contained in air flowing into the flow path housing; and
a door disposed between the flow path housing and the carbon dioxide capture module, the door being configured to selectively open or close the flow path housing.

2. The air-conditioning system according to claim 1, wherein, when the door opens the flow path housing, carbon dioxide is captured in the carbon dioxide capture module, and
wherein, when the door closes the flow path housing, carbon dioxide captured in the carbon dioxide capture module is desorbed therefrom.

3. The air-conditioning system according to claim 2, further comprising:
a mode-switching door configured to switch an air supply mode to any one of an internal air mode in which the blower unit communicates with the internal air flow path and an external air mode in which the blower unit communicates with the external air flow path,
wherein, in the internal air mode, the door opens the flow path housing, and the carbon dioxide capture module captures carbon dioxide contained in air introduced through the internal air flow path.

4. The air-conditioning system according to claim 3, wherein, when the mode-switching door switches the air supply mode to the external air mode, the door closes the flow path housing and the blower unit discharges carbon dioxide desorbed from the carbon dioxide capture module to the external air flow path.

5. The air-conditioning system according to claim 3, wherein the carbon dioxide capture module is arranged between the blower unit and the flow path housing.

6. The air-conditioning system according to claim 5, wherein the carbon dioxide capture module is arranged between the blower unit and an evaporator that is configured to cool air introduced into the flow path housing.

7. The air-conditioning system according to claim 3, wherein the carbon dioxide capture module is arranged between the internal air flow path and the blower unit.

8. The air-conditioning system according to claim 2, wherein the carbon dioxide capture module comprises:
a carbon dioxide absorbent to which carbon dioxide is adsorbed; and
a heater configured to heat the carbon dioxide absorbent.

9. The air-conditioning system according to claim 8, wherein, when the carbon dioxide absorbent is heated to a first temperature range, carbon dioxide is adsorbed to the carbon dioxide absorbent, and
wherein, when the carbon dioxide absorbent is heated to a second temperature range, which is higher than the first temperature range, carbon dioxide adsorbed to the carbon dioxide absorbent is desorbed therefrom.

10. The air-conditioning system according to claim 9, wherein the first temperature range is 30 to 80° C., and
wherein the second temperature range is 90° C. or higher.

11. The air-conditioning system according to claim 8, wherein the heater comprises a planar heating element stacked on one surface of the carbon dioxide absorbent.

12. The air-conditioning system according to claim 11, further comprising:
a protective layer stacked on an opposite surface of the carbon dioxide absorbent, the protective layer being configured to allow air to pass therethrough.

13. A carbon dioxide capture module, comprising:
a carbon dioxide absorbent disposed in a flow path along which air flows into an interior of a vehicle, the carbon dioxide absorbent being configured to selectively adsorb carbon dioxide; and
a heater configured to heat the carbon dioxide absorbent.

14. The carbon dioxide capture module according to claim 13, wherein, when the carbon dioxide absorbent is heated to a first temperature range, carbon dioxide is adsorbed to the carbon dioxide absorbent, and
wherein, when the carbon dioxide absorbent is heated to a second temperature range, which is higher than the first temperature range, carbon dioxide adsorbed to the carbon dioxide absorbent is desorbed therefrom.

15. The carbon dioxide capture module according to claim 14, wherein the first temperature range is 30 to 80° C., and
wherein the second temperature range is 90° C. or higher.

16. The carbon dioxide capture module according to claim 13, wherein the heater comprises a planar heating element stacked on one surface of the carbon dioxide absorbent.

17. The carbon dioxide capture module according to claim 16, further comprising:
a protective layer stacked on an opposite surface of the carbon dioxide absorbent, the protective layer being configured to allow air to pass therethrough.
